(19) United States
(12) Patent Application Publication
(10) Pub. No.: US 2002/0042259 A1
(43) Pub. Date: Apr. 11, 2002

(54) System for establishing personal contacts

(76) Inventor: Stelian-Adrian Goia, Wien (AT)

Correspondence Address: Connolly Bove Lodge & Hutz LLP, Suite 800, 1990 M Street, N.W., Washington, DC, 20036-3425, US

(21) Appl. No.: 09/874,373

(22) Filed: Jun. 6, 2001

(30) Foreign Application Priority Data
Sep. 29, 2000 (FI) 20002140

(51) Int. Cl. H04Q 7/20; H04M 11/00

(52) U.S. Cl. 455/403

(57) ABSTRACT

A system for establishing personal contacts, comprising a number of data processing devices (x) which are portable and most conveniently fitted with a built-in power supply (ps), each device being provided with contact making capabilities for establishing a contact, preferably in a wireless manner, between other data processing devices located essentially within close range. The system is particularly intended for establishing a personal contact between at least two persons or among a group of people (1) who have activated themselves in their personal data processing device (x′) regarding a common subject matter (hi) in such a way that, whenever in an active scanning mode, each data processing device (x′) included in the system monitors continuously its environment and is able to single out one or more other data processing devices (x′) present within the confines of its scanning environment and having activated therein the same subject matter (hi), such as one or more search criteria or the like.

The invention relates to a system for establishing personal contacts, comprising a number of data processing devices which are portable and most conveniently fitted with a built-in power supply, each device being provided with contact making capabilities for establishing a contact, preferably in a wireless manner, between other data processing devices located essentially within close range.

The above-described logic represents e.g. a situation today, wherein two persons set up a mutual meeting e.g. by calling each other with a cellular telephone or text messages and by agreeing upon a procedure to establish a personal contact with each other. However, a condition for the above course of action is always that at least one party knows the telephone number of another person, and thus, in this respect, the question is not so much about establishing new unexpected personal contacts but generally about a practical arrangement of e.g. meetings set up earlier. In addition, this type of action makes it difficult to maintain anonymity, if, for any reason, the revelation of personal identity is not desirable. Furthermore, it will be necessary to take up services of chargeable telephone networks.

On the other hand, in purely technical sense, there are currently available systems, wherein the action is based on data processing devices with contact making capabilities searching a contact with each other and performing necessary measures automatically. This type of applications are represented e.g. by so-called pocket or palm computers, which can be synchronized with a computer, such as a PC, by way of communication ports present in such devices. In this conjunction, communication between devices occurs in practice either by way of a wire or in a wireless fashion, e.g. through infrared technology. This type of solutions are likewise always intended for carrying out a given function only or, as in the above example, for synchronizing selected files, such as a customer register, a calendar, a task list, e-mail messages and/or the like, between a pocket or palm computer and the actual computer. Due to the self-functioning and active nature thereof, this type of systems can be anticipated to have problems, if a computer, a pocket or palm computer equipped with some automated synchronizing program is linked with other external components capable of self-acting synchronization.

The present system for establishing personal contacts is intended to provide a completely new operating principle, particularly for creating new and/or unexpected personal contacts or e.g. for setting up previously agreed meetings in a large crowd without requirements and restrictions of traditional technology. The system of the invention is principally characterized by being particularly intended for establishing a personal contact between at least two persons or among a group of people who have activated themselves in their personal data processing device regarding a common subject matter in such a way that, whenever in an active scanning mode, each data processing device included in the system monitors continuously its environment and is able to single out one or more other data processing devices present within the confines of its scanning environment and having activated therein the same subject matter, such as one or more search criteria or the like.

The most significant benefits gained by the system of the invention include especially the simplicity of its operating principle and hardware stock compatible therewith, yet it has a virtue of enabling a crucial assistance and facilitation e.g. to the establishment of new and/or unexpected personal contacts without being dependent on e.g. chargeable telephone networks or communication links. The inventive system is applicable in most diverse circumstances and environments for the most diversified of intentions. Thus, the intention of continuous scanning may be e.g. a work- or purely leisure-related interest in meeting persons interested in the same matters. On the other hand, the reason for searching personal contacts may also arise from other personal needs or from a purely practical aspect of meeting a previously unknown person in a crowd.

One essential advantage of the inventive system is its ability to implement the establishment of personal contacts in a preferred fashion, yet by largely exploiting technology already in existence. Thus, in a particularly preferred application, the system can be implemented e.g. on a software basis in such a way that the data processing equipment included in the system, possibly comprising devices developed especially for the purpose or e.g. accessories or programs for existing devices, such as mobile or cellular telephones, is configurable e.g. by way of the internet in addition to its own installation programs. This makes it possible e.g. to standardize within the system confines a certain keywords library for ensuring that basically the same terminology is applied to the same topics all over the world. Regarding the linguistic problems, it is naturally further possible to establish a keywords library single- or multi-lingually, such that the comparison effected on the basis of a keywords library in a given language can nevertheless be carried out without language barriers. This can be realized e.g. in such a way that the matching terminologies in various languages are linked to each other with some sort of standard code system or the like.

In the following specification, the invention will be described in detail with reference made to the accompanying drawings, in which

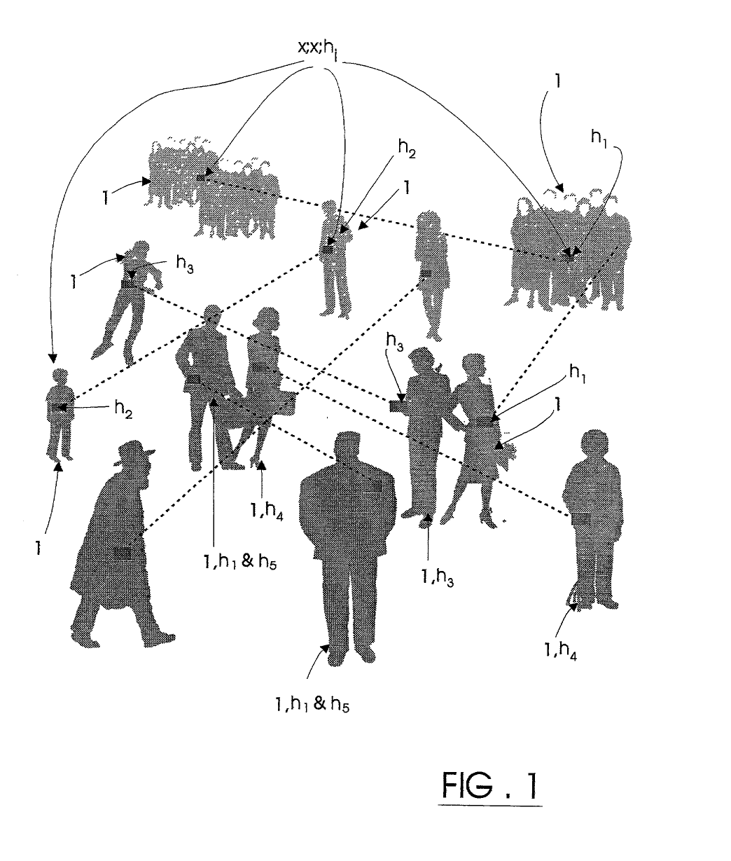

FIG. 1 shows a general operating principle for a system of the invention,

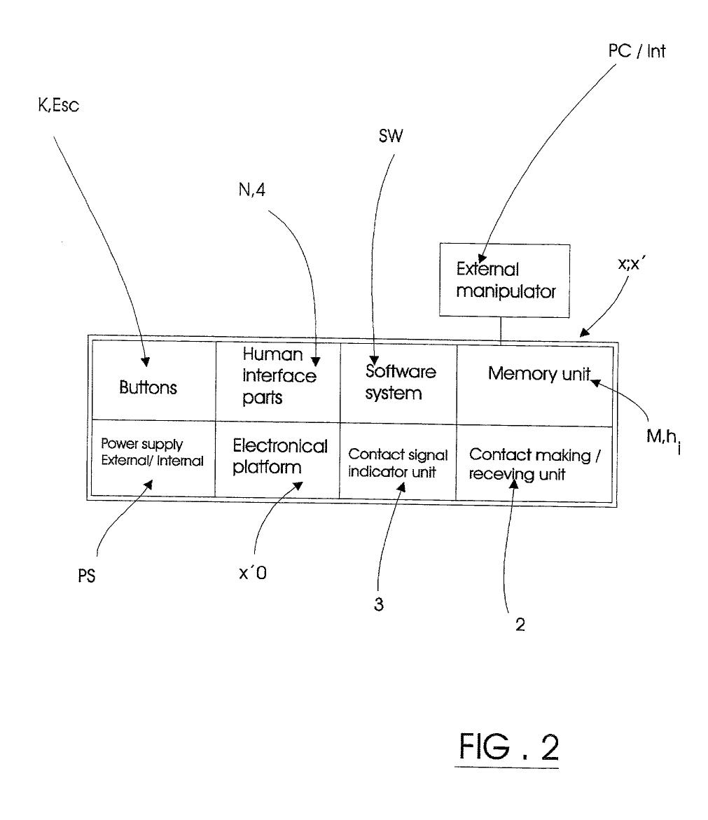

FIG. 2 shows a general principle for one preferred configuration of a data processing device included in a system of the invention,

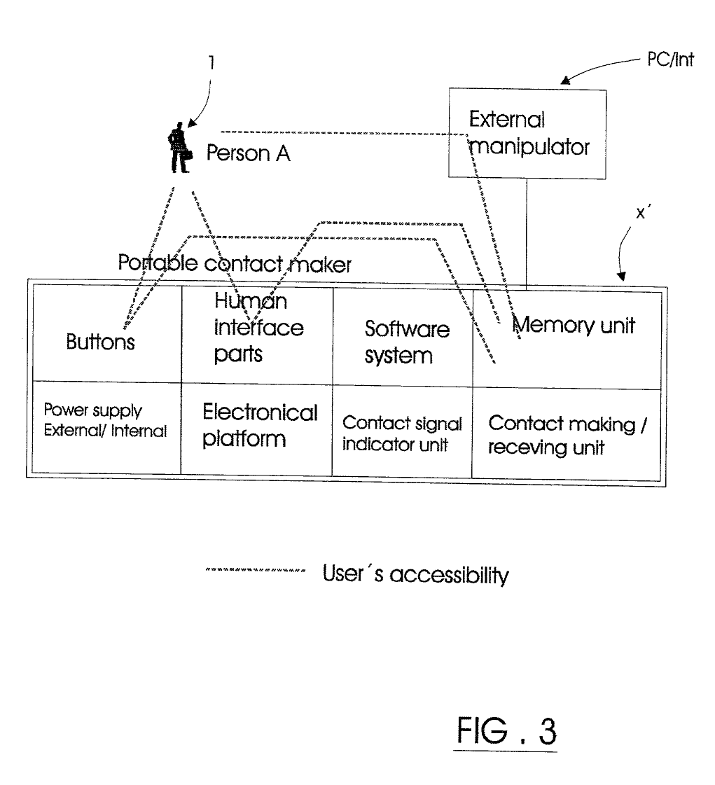

FIG. 3 shows in principle how a user is able to operate with a data processing device designed according to the principle of FIG. 2,

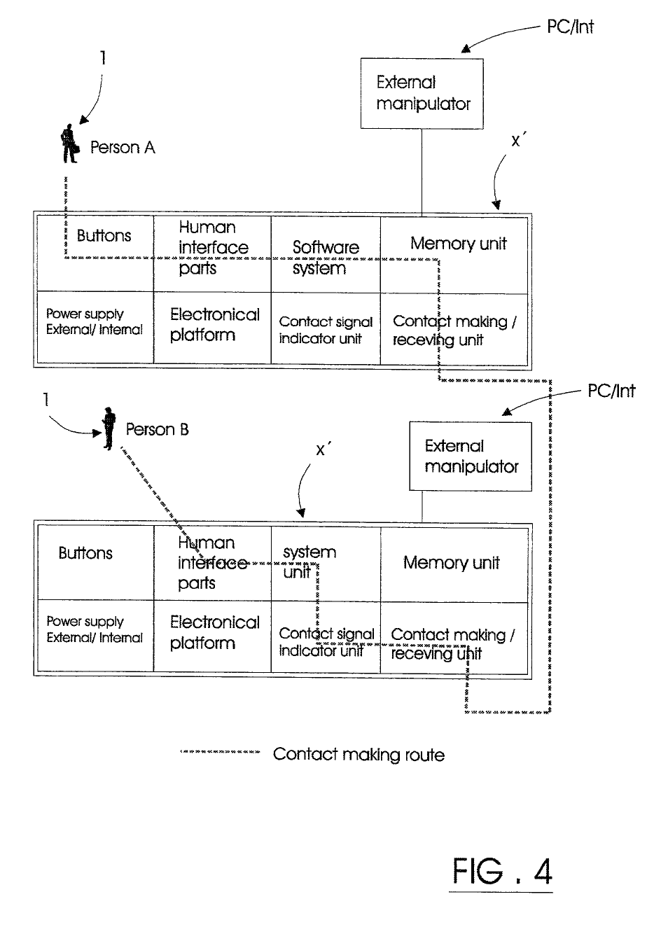

FIG. 4 shows one preferred principle regarding a contact making process between data processing devices exhibiting the type of assembly shown in FIGS. 2 and 3, and

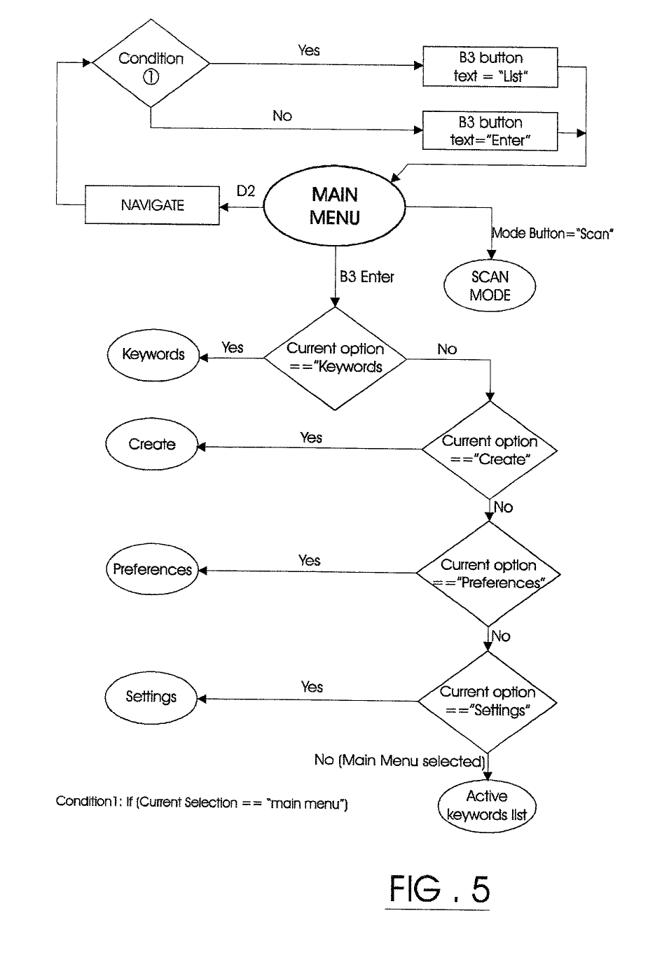

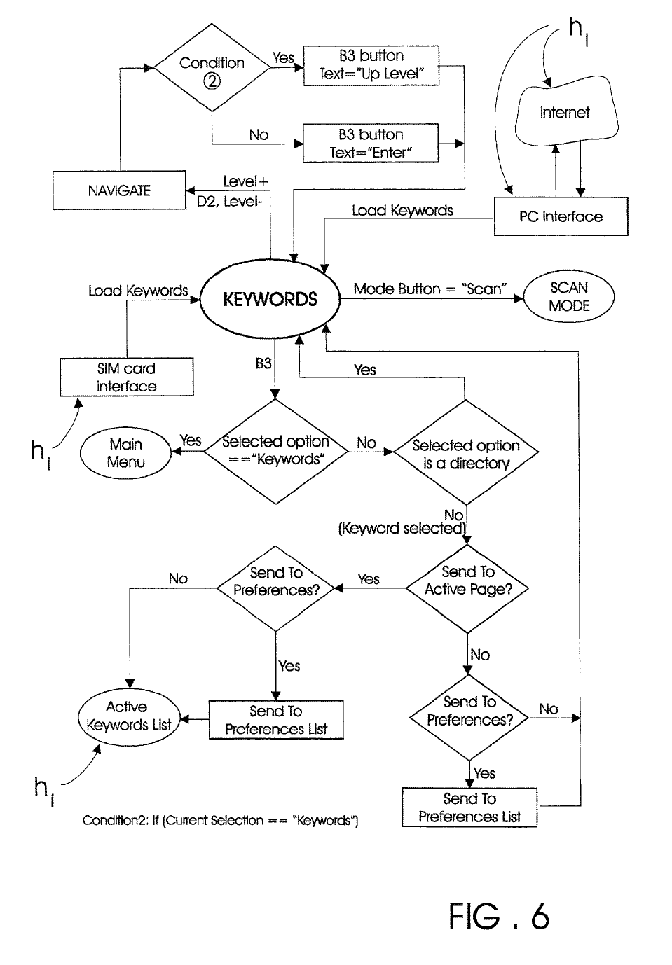

FIGS. 5-7 show a few preferred applications for the programming logic of data processing devices included in the system, regarding certain essential functions.

The invention relates to a system for establishing personal contacts, comprising a plurality of data processing devices x, which are portable and preferably equipped with a built-in power supply ps, each of said devices being provided with contact making capabilities for establishing a contact most preferably in a wireless manner between other data processing devices present within close range. The system is particularly intended for establishing a personal contact between at least two persons activated in their personal data processing device x′ for a common subject matter or topic hi, or among a group of people 1, in such a way that, whenever in an active scanning mode, each data processing device x′ included in the system monitors continuously its environment and is able to single out one or more other data processing devices x′ present within the confines of its scanning environment and having activated therein the same subject matter hi, such as a search criterion or the like.

The system includes an application environment for using preferably e.g. a computer PC and/or the internet Int to upload the data processing devices x′ with search criteria hi, such as a keywords library, standardized within the system confines, available for scanning the environment.

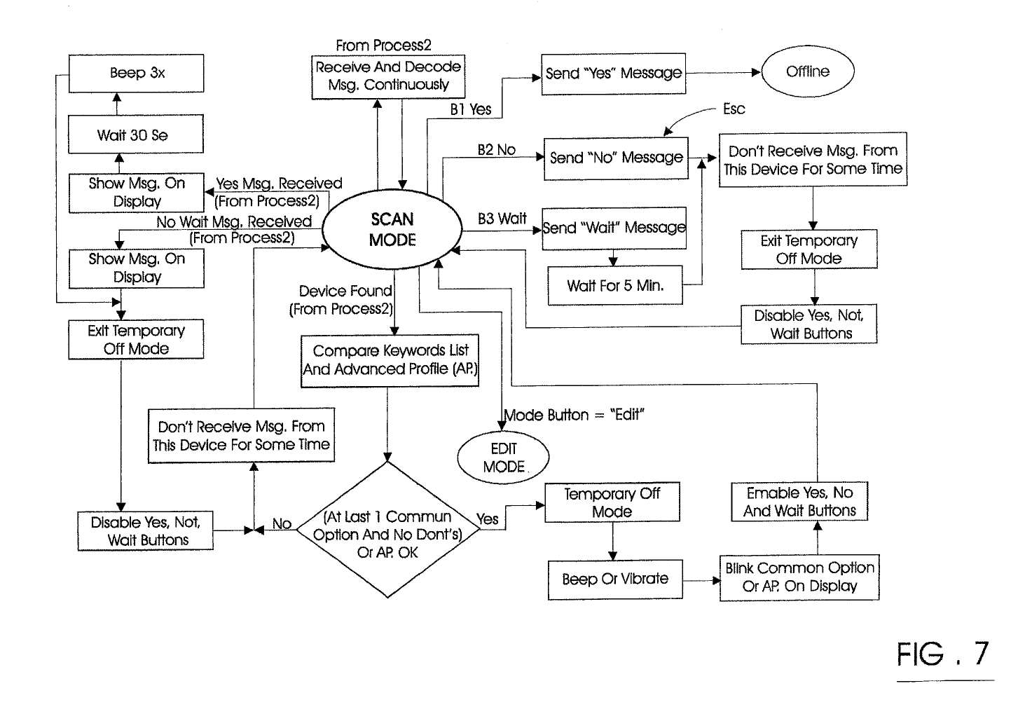

Referring especially to the preferred applications shown in FIGS. 2-6, the data processing devices x′ included in the system are each provided with an operating system, program and/or software x′o, which enables the selection of one or more desired search criteria hi, the activation thereof into a memory M in connection with the data processing device, and, in a scanning situation, the comparison thereof, according to the principle shown in FIG. 7, with other active search criteria located in the scanning environment, for making it possible, according to the principle of FIG. 1, to establish a personal contact with two or more persons or a group of people 1 who have activated the same search criterion hi.

Hence, the data processing devices x′ included in the system are equipped with scanning elements 2 for enabling a continuous monitoring of the environment in a scanning situation on the basis of any one or more selected search criteria hi in a wireless fashion, such as by using infrared, radio frequency, Bluetooth technology and/or the like.

The data processing devices x′ included in the system are further equipped with mechanical, voice-activated, light-activated and/or the like alarm elements 3 for detecting the appearance in the scanning environment of one or more other data processing devices x′, having the same search criterion hi activated therein. In this connection, it is naturally plausible to use combinations of the above, such as combinations of a vibrator and a light indicator, etc.

In a further preferred embodiment, the data processing devices x′ included in the system are provided with guidance elements 4 e.g. programmatically in connection with a display N for determining a direction, an angle or a corresponding position for the location of that other data processing device x′ which has turned up as a result of scanning and matches one or more activated search criteria hi.

In reference e.g. to FIGS. 2-4 or diagram 6, a preferred embodiment of the system further comprises an application environment to be upheld/updated programmatically, such as on the basis of software sw and/or internet Int, for using the system-standardized search criteria hi, such as keywords libraries, in the data processing devices x′.

It is naturally obvious that, instead of or in addition to the above, it will be possible to use also keywords/programs loaded in external memory cards (Smartcard, Flashcard, SIM-card or the like).

On the other hand, e.g. FIGS. 2-4 depict data processing devices x′ included in the system, which can be adapted to be manually operated according to the principle shown in diagram 5, such that the search criterion hi to be activated at any given time is determinable by means of a keyboard K through tapping, by way of a display N through exploiting graphic text identification and/or in the like fashion, by using a freely optional character or string, such as a word, a code, an address, a name, a phone number, an e-mail address and/or the like.

In reference to the preferred configuration shown in FIGS. 2-4, the data processing devices x′ included in the system are equipped, as depicted in diagram 7, with an abortion feature Esc for breaking the connection between two data processing devices x′ having established a contact with each other, if there is after all no mutual interest or possibility of establishing an actual personal contact at this time. In this respect, it is also possible to exploit, as depicted in diagram 7, a so-called standby feature, such that the establishment of a located contact is confirmable with an optional delay.

In a further preferred embodiment, the application environment included in the system is adapted to facilitate a discretionary comparison in such a way that, as search criteria hi, it is possible to employ a Boolean algebra (and, or, no), a fuzzy logic, and/or other such analysis between two or more selected search criteria for limiting the conditions for an acceptable personal contact.

It is obvious that the invention is not limited to the above-depicted or -described embodiments as it can be subjected to a wide range of modifications within the scope of the basic inventive concept, since both the practical application possibilities and demand for this type of system are very substantial indeed. Moreover, when it comes to hardware technology, it is first of all possible to outfit a data processing device intended for use in the system with replaceable accumulators or batteries according to conventional practice, as well as with terminals for operating the device or for charging its batteries with a separate power pack. In addition, it is preferred that the discussed device be fitted with a suitable communication port, which can be effected either in a wired fashion by using a traditional serial, parallel, USB port or the like or in a wireless manner by using e.g. an infrared, Bluetooth or the like connection. Naturally, it is likewise obvious that each optional search criterion can be further classified on a low-high scale or in a similar manner, such that, in a contact making situation, the contact is established only between devices having a higher activity in case the scanning environment contains several devices focused on the same activity. Accordingly, in certain conditions, it may be very useful indeed to outfit the data processing devices with control elements for determining a scanning environment for its radius or a corresponding scanning range in order to acquire a rough knowledge of the sort of area that the discovered counter-contact is detected from. This type of information may of course be shown also on the display screen of each data processing device during a contact making process. Furthermore, and especially when using a so-called standby feature, it is also possible to proceed in such a manner that, on the basis of a discovered contact, the device can be used for delivering some sort of contact making information, such as e.g. an e-mail address or a phone number, for subsequent contact making.

On the other hand, it is of course clear that the data processing devices compatible with the system can be designed, as described above, by using hardware explicitly developed for the system or by modifying other existing hardware, e.g. by fitting the same with a software or hardware environment capable of making the system operable. Thus, it is naturally obvious that the inventive system is implementable with solutions carried out e.g. in a cellular telephone environment, such that, in principle, the system is capable of working through the intermediary of a cellular phone provided with wireless scanning elements. In this regard, it is of course possible to use also so-called electronic notebooks designed with similar accessories, such as hand-held or pocket computers, not to mention other future portable data processing equipment.

Scanning can be carried out also by using other arrangements operating in a wireless manner, whereby the operating range should probably and most preferably be limited to a few hundred meters or else the system should be further provided with GPS equipment or the like position fixing for enabling an exact positioning of persons participating in a contact. In this context, it should be noted that, for example, the scanning performed with radio frequency technology has an operating radius which is naturally longer than that of the solution implemented with infrared technology, in which case the entity completed with the above type of positioning equipment has its operating radius further extended from its previous value, since persons making contact with each other even from quite a long distance can be guided to communication with each other by means of the system.

What is claimed is:

1. A device used in a system for establishing personal contacts between two or more persons comprising:
a plurality of portable data processing devices, each having a wireless transmission and reception system, and each having a processor programmed to:
store a plurality of search criteria for comparing with a search criteria stored in another data processing device;
transmit over said wireless transmission and reception system a search criteria selected from said plurality of search criteria;
establish a radio communication link with another proximately located data processing devices which receive said search criteria;
transmit over said communication link an acknowledgement when a search criteria is received matching a search criteria which is stored in a data processing device receiving said search criteria; and
mutually identify each data processing device to each other when mutual search criteria is acknowledged by one of said data processing devices.

2. The device according to claim 1, wherein each of said portable data processing devices includes means for entering said search criteria in said portable data processing devices.

3. The device according to claim 1, further comprising means for selecting said search criteria from a plurality of stored criteria.

4. The device according to claim 1, wherein said portable data processing devices are further programmed to:
continuously transmit said criteria to the remaining devices to establish communications with one or more of said remaining devices having the same search criteria.

5. The device according to claim 1, further comprising an alarm device for alerting a user of said devices that an acknowledgement has been received.

6. The device according to claim 1, wherein each of said devices transmitting said search criteria includes a direction indicating device for locating the position of a device issuing an acknowledgement.

7. The device according to claim 6, wherein said portable device includes a data interface for updating said processor search criteria from an external source of computer programming.

8. The device according to claim 1, further comprising a display for indicating the identity of a device which is acknowledging a transmitted search criteria.

9. The device according to claim 1, wherein said devices include personal information which is exchanged between devices which are in communication with each other.

10. The device according to claim 1, further comprising a user operated means for terminating communications between devices.

11. The device according to claim 1, wherein each of said devices are programmed to perform a comparison between a received search criteria an a stored criteria, and for deciding whether said received and stored criteria have a predetermined relationship.
